(19) United States
(12) Patent Application Publication
(10) Pub. No.: US 2005/0211322 A1
(43) Pub. Date: Sep. 29, 2005

(54) Expandable tubular element for use in a wellbore

(76) Inventor: Wilhelmus Christianus Maria Lohbeck, Rijswijk (NL)

Correspondence Address: Del S Christensen;Shell Oil Company, Intellectual Property, P O Box 2463, Houston, TX, 77252-2463, US

(21) Appl. No.: 10/524,463

(22) PCT Filed: Aug. 8, 2003
(86) PCT No.: PCT/EP03/08843

§ 371 Date: Feb. 14, 2005

(30) Foreign Application Priority Data
Aug. 8, 2002 (EP) 02255562.7

(51) Int. Cl. F16L 11/00

(52) U.S. Cl. 138/115; 138/98

(57) ABSTRACT

An expandable tubular element having a wall including at least a portion formed of a plurality of stacked wall layers, each wall layer having a bent configuration in a cross-sectional plane prior to radial expansion of the tubular element and being arranged to deform from the bent configuration to a more stretched configuration upon radial expansion of the tubular element.

The present invention relates to an expandable tubular element for use in a wellbore formed in an earth formation. The tubular element can be, for example, a casing which is installed in the wellbore to strengthen the borehole wall and to prevent collapse of the wellbore. In a conventional wellbore one or more casings strings are installed in the wellbore as drilling proceeds, whereby after drilling a new wellbore section a subsequent casing must pass through the previously installed casing strings. In view thereof the subsequent casing must be of smaller diameter than the previously installed casing strings. A consequence of such arrangement is that the wellbore diameter available for tools or fluids to pass through the wellbore becomes smaller with increasing number of casing strings (i.e. with increasing depth).

It has been proposed to alleviate this problem by installing each subsequent casing in a manner that the subsequent casing extends only for a short length into the previous casing rather than into the whole length of the previous casing. Such subsequent casing is then generally referred to as a liner. By radially expanding the subsequent casing after its installation at the required depth to an inner diameter substantially equal to the inner diameter of the previous casing, or just the wall thickness smaller, it is achieved that a decrease of the available inner diameter with depth is significantly reduced or avoided. Even if the subsequent casing is only expanded to the extent that its inner diameter is the wall thickness smaller than the inner diameter of the previous casing, a significant reduction of the telescoping effect of conventional casing schemes is achieved.

However, it has been found that the expansion forces required to expand the tubular element are generally high. The problem is even more pronounced at the overlapping portions of subsequent casing sections. In view of such high expansion forces there is a risk that the expander which is moved (e.g. by pulling, pushing, rotating or pumping) through the tubular element to expand same, becomes stuck in the tubular element. Also there is a risk that tubular element, or a connector thereof, bursts as a result of the high expansion forces.

Accordingly it is an object of the invention to provide an improved expandable tubular element for use in a wellbore, which overcomes the problem indicated above.

In accordance with the invention there is provided an expandable tubular element having a wall including at least a portion formed of a plurality of stacked wall layers, each wall layer having a bent configuration in a cross-sectional plane prior to radial expansion of the tubular element and being arranged to deform from the bent configuration to a more stretched configuration upon radial expansion of the tubular element.

Each wall layer deforms elastically/plastically during the expansion process, from the bent configuration to the more stretched configuration. The bending moment required for unbending a single wall layer is proportional to the thickness (h) of the wall layer to the power three (i.e. h³). For n wall layers, the total bending moment required to deform all wall layers simultaneously is therefore n*h³. It will be understood that such total bending moment is significantly lower than the bending moment required to unbend a wall portion not formed of stacked wall layers (i.e. a solid wall portion) and of thickness n*h. Namely the latter bending moment is proportional to (n*h)³ which is significantly larger than n*h³. In consequence thereof the expansion force required to expand the tubular element provided with the stacked wall layers is significantly lower than for a tubular element not provided with the stacked wall layers, but which is otherwise similar in shape and mechanical properties. After the radial expansion process, the tensile strength in circumferential direction of the tubular element is similar to that of a conventional tubular element (i.e. not provided with the stacked wall layers). This is an important feature since the burst pressure after radial expansion is virtually unaffected by the provision of the stacked wall layers.

Suitably said wall layers have mutually different bending curvatures prior to expansion of the tubular element.

In an attractive embodiment of the tubular element of the invention, the tubular element is one of a pair of tubes whereby an end part of an inner tube extends into an end part of an outer tube, and wherein said portion of stacked wall layers is included in one of said end parts. Preferably said portion of stacked wall layers is included in the end part of the outer tube.

Sliding of the wall layers along each during unbending other is promoted if a layer of lubricant or coating of low friction is included between each pair of adjacent wall layers.

The invention will be described hereinafter in more detail and by way of example with reference to the accompanying drawings in which:

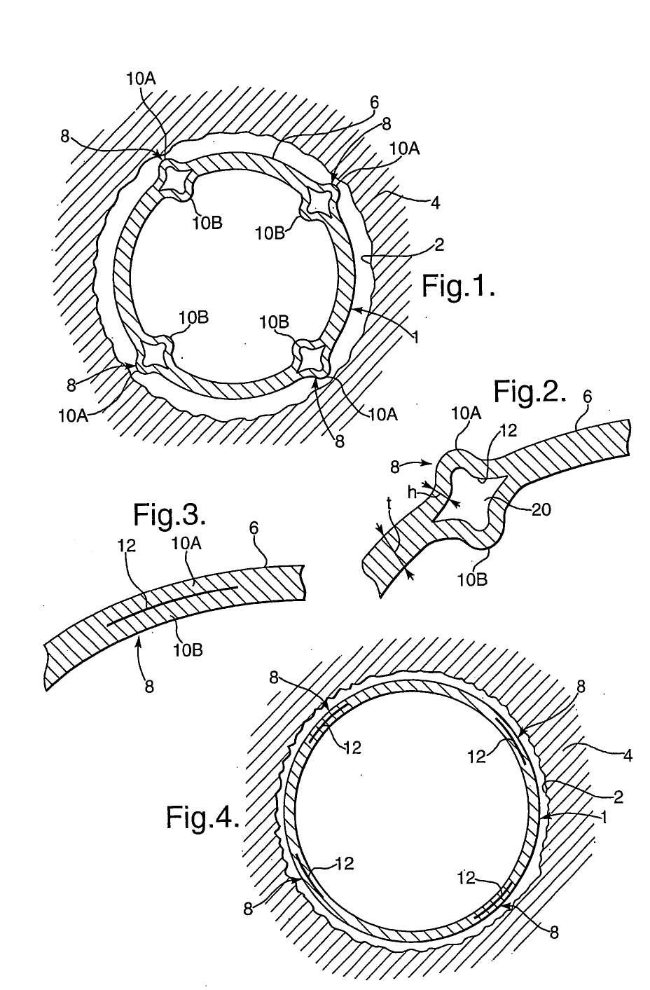

FIG. 1 schematically shows an embodiment, in cross-section, of an expandable tubular element according to the invention;

FIG. 2 schematically shows a detail of the embodiment of FIG. 1 before radial expansion of the tubular element;

FIG. 3 schematically shows the detail of FIG. 2 after radial expansion of the tubular element; and

FIG. 4 schematically shows the tubular element of FIG. 1 after radial expansion thereof.

In the Figures like reference numerals relate to like components.

Referring to FIG. 1 there is shown a tubular element in the form of a wellbore casing 1 extending substantially coaxially into a wellbore 2 formed into an earth formation 4. The casing 1 has a wall 6 which includes a number of portions 8 formed of a pair of stacked wall layers 10A, 10B. Each portion 8 of stacked wall layers 10A, 10B extends in substantially longitudinal direction of the casing 1. The thickness (h) of each wall layer 10A, 10B is about half the thickness (t) of the sections of wall 6 in between the. portions 8. The wall layer 10A of each pair has been bent radially outward, and the wall layer 10B of the pair has been bent radially inward.

In FIG. 2 is shown one of the wall portions 8 in more detail, whereby it is shown that a slit 12 extends through the wall 6 so as to divide the wall into wall layers 10A, 10B.

In FIG. 3 is shown the wall portion 8 after radial expansion of the casing 1, whereby the wall layers 10A, 10B have been plastically deformed from the bent configuration shown in FIG. 2 to a configuration in which the wall layers 10A, 10B have been stretched so as to extend substantially in circumferential direction of the casing 1. The slit 12 now also extends in substantially circumferential direction of the casing 1. During normal use the casing 1 is to be positioned into a newly drilled portion of the wellbore. Therefore the casing 1 is lowered through a previously installed casing (not shown) whereby the casing 1 has the retracted configuration shown in FIG. 1. Thus the largest outer diameter of the casing 1 must be smaller than the inner diameter of the previously installed casing. After the casing 1 has been positioned at the desired depth, an expander mandrel (not shown) is moved through the casing 1 in order to radially expand the casing 1 to a diameter substantially equal to the diameter of the previously installed casing. During the expansion process the wall portions 8 are stretched in circumferential direction whereby the wall layers 10A, 10B plastically deform from the bent configuration of FIG. 2 to the stretched configuration of FIG. 3.

The bending moment required to deform each wall layer 10A, 10B from the bent configuration to the stretched configuration is proportional to the thickness (h) to the power third, i.e. proportional to h³. This is because the bending moment is proportional to the surface moment of inertia I_{z} for bending about an axis z extending in longitudinal direction of the casing 1, and because I_{z} is proportional to h³. Therefore the total bending moment (Mₜ) required to deform the two wall layers 10A, 10B simultaneously is proportional to 2*h³. The bending moment required to bent a portion of the wall 6 without slit is proportional to t³. With t=2*h it follows that such bending moment is proportional to 8*h³. Thus, the bending moment Mₜ required to deform each wall portion 8 from the bent configuration to the stretched configuration is significantly lower than the bending moment required to bent a portion of the wall 6 without slit. Consequently, the expansion force required to expand the casing 1 from the retracted configuration (FIG. 1) to the expanded configuration (FIG. 4) is significantly lower than the expansion force which would be required to expand a tube without the slits 12 and whereby expanding mechanism is bending of the wall of the tube (e.g. expansion of a corrugated tube without slits).

Furthermore, it will be understood that after radial expansion the casing 1 has a resistance against collapse due to external pressure, and a resistance against burst due to internal pressure, comparable to a similar tube without slits. This can be understood by considering that there is no reduction in wall thickness at the locations of the slits 12, i.e. the total wall thickness at these locations is 2*h=t.

Instead of providing the tubular element with separate portions of stacked wall layers along the circumference, the stacked wall layers can extend along the entire circumference of the tubular element. In such application the tubular element can, for example, have a corrugated shape prior to expansion.

The volume enclosed by the wall layers 10A, 10B prior to expansion, forms a cavity 20 which can be filled with a fluid, for example a lubricant or coating to promote sliding of said adjacent wall layers 10A, 10B along each other during expansion of the tubular element.

To accommodate the volume change of the cavity 20 during expansion of the tubular element 1, at least one of the wall layers 10A, 10B can be provided with an opening (not shown) arranged to allow fluid to be expelled from the cavity 20 during expansion of the tubular element 1.

Preferably the fluid forms a bonding agent or a compound for forming a bonding agent, which bonding agent is suitable to bond said adjacent wall layers 10A, 10B to each other or to bond the tubular element to a wall (not shown) extending adjacent the tubular element 1. In case the bonding agent bonds the adjacent wall layers 10A, 10B to each other, a significant increase of the collapse strength of the tubular element 1 is achieved after its expansion.

The wall to which the tubular element 1 can be bonded can be, for example, the wall of another tubular element (not shown) or the wall of the wellbore 2 into which the tubular element 1 extends.

Suitably said cavity forms a first cavity containing a first bonding compound for forming a bonding agent, and wherein a second said cavity (not shown) contains a second compound which reacts with the first compound to form the bonding agent.

1. An expandable tubular element having a wall including at least a portion formed of a plurality of stacked wall layers, each wall layer having a bent configuration in a cross-sectional plane prior to radial expansion of the tubular element and being arranged to deform from the bent configuration to a more stretched configuration upon radial expansion of the tubular element, wherein the tubular element includes at least one cavity, each cavity being formed between a pair of adjacent wall layers prior to expansion of the tubular element, said cavity containing a body of fluid in the form of a bonding agent or a compound for forming a bonding agent, which bonding agent is suitable to bond said adjacent wall layers to each other or to bond the tubular element to a wall extending adjacent the tubular element.

2. The expandable tubular element of claim 1, wherein said wall layers have mutually different bending curvatures prior to radial expansion of the tubular element.

3. The expandable tubular element of claim 1, including a plurality of said portions of stacked wall layers spaced along the circumference of the tubular element.

4. The expandable tubular element of claim 1, wherein said portion of stacked wall layers extends along the full circumference of the tubular element.

5. The expandable tubular element of claim 4, wherein the tubular element has, prior to radial expansion thereof, a corrugated shape.

6. The expandable tubular element of claim 1, wherein the tubular element is one of a pair of tubes whereby an end part of an inner tube extends into an end part of an outer tube, and wherein said portion of stacked wall layers is included in one of said end parts.

7. The expandable tubular element of claim 6, wherein said portion of stacked wall layers is included in the end part of the outer tube.

8. The expandable tubular element of claim 1, wherein at least one of said adjacent wall layers is provided with an opening arranged to allow fluid from said body of fluid to be expelled from the cavity during expansion of the tubular element.

9. The expandable tubular element of claim 1, wherein said wall is the wall of another tubular element or the wall of a wellbore into which the tubular element extends.

10. The expandable tubular element of claim 8, wherein said cavity forms a first cavity containing a first bonding compound for forming a bonding agent, and wherein a second said cavity contains a second compound which reacts with the first compound to form the bonding agent.

11. The expandable tubular element of claim 1, wherein the tubular element extends into a borehole formed in an earth formation.

12. (canceled)

13. The expandable tubular element of claim 2, including a plurality of said portions of stacked wall layers spaced along the circumference of the tubular element.

14. The expandable tubular element of claim 2, wherein said portion of stacked wall layers extends along the full circumference of the tubular element.

15. The expandable tubular element of claim 2, wherein the tubular element is one of a pair of tubes whereby an end part of an inner tube extends into an end part of an outer tube, and wherein said portion of stacked wall layers is included in one of said end parts.

16. The expandable tubular element of claim 3, wherein the tubular element is one of a pair of tubes whereby an end part of an inner tube extends into an end part of an outer tube, and wherein said portion of stacked wall layers is included in one of said end parts.

17. The expandable tubular element of claim 4, wherein the tubular element is one of a pair of tubes whereby an end part of an inner tube extends into an end part of an outer tube, and wherein said portion of stacked wall layers is included in one of said end parts.

18. The expandable tubular element of claim 5, wherein the tubular element is one of a pair of tubes whereby an end part of an inner tube extends into an end part of an outer tube, and wherein said portion of stacked wall layers is included in one of said end parts.

19. The expandable tubular element of claim 9, wherein said cavity forms a first cavity containing a first bonding compound for forming a bonding agent, and wherein a second said cavity contains a second compound which reacts with the first compound to form the bonding agent.
